(19) United States
(12) Patent Application Publication
(10) Pub. No.: US 2013/0027320 A1
(43) Pub. Date: Jan. 31, 2013

(54) ELECTRONIC DEVICE WITH ACCESSIBLE USER INTERFACE FOR VISUALLY IMPARIED

(71) Applicants: TING-SHE CHANG, Tu-Cheng (TW); TSUNG-JEN CHUANG, Tu-Cheng (TW); SHIH-FANG WONG, Tu-Cheng (TW)

(72) Inventors: TING-SHE CHANG, Tu-Cheng (TW); TSUNG-JEN CHUANG, Tu-Cheng (TW); SHIH-FANG WONG, Tu-Cheng (TW)

(73) Assignee: HON HAI PRECISION INDUSTRY CO., LTD., Tu-Cheng (TW)

(21) Appl. No.: 13/237,944

(22) Filed: Sep. 21, 2011

(30) Foreign Application Priority Data
Jul. 25, 2011 (CN) 201110208701.0

(51) Int. Cl. G06F 3/041

(52) U.S. Cl. 345/173

(57) ABSTRACT

An electronic device with a feedback work-mode includes a touch screen for displaying at least one user interface and each user interface includes at least one touch button. An audio message set for each user interface is for indicating the touch buttons comprised in the user interface. The electronic device further includes a vibration panel included a plurality of vibrating elements. The vibrating elements are set adjacent each touch button. The electronic device accesses the audio message associated with that particular user interface to output if the electronic device is operable to display one of the at least one user interface, determines the position of the touch buttons comprised in the user interface, determines the vibration elements located near the touch button according to the determined positions, and controls the vibration elements corresponding to the touch button to vibrate.

### BACKGROUND

1. Technical Field

The present disclosure relates to an electronic device, particularly relates to an electronic device with an accessible user interface for the visually impaired.

2. Description of Related Art

Generally, special electronic devices designed for users with serious visual impairment provide Braille keys. However, such devices are not readily available and may be expensive, on the other hand, however, standard electronic devices do not provide Braille keys and thus are not easy to be used by the visually impaired.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a user interface of an electronic device with a feedback work-mode in accordance with an exemplary embodiment.

FIG. 2 is a block diagram of the electronic device of FIG. 1 in accordance with a first exemplary embodiment.

FIG. 3 is a block diagram of the electronic device of FIG. 1 in accordance with a second exemplary embodiment.

### DETAILED DESCRIPTION

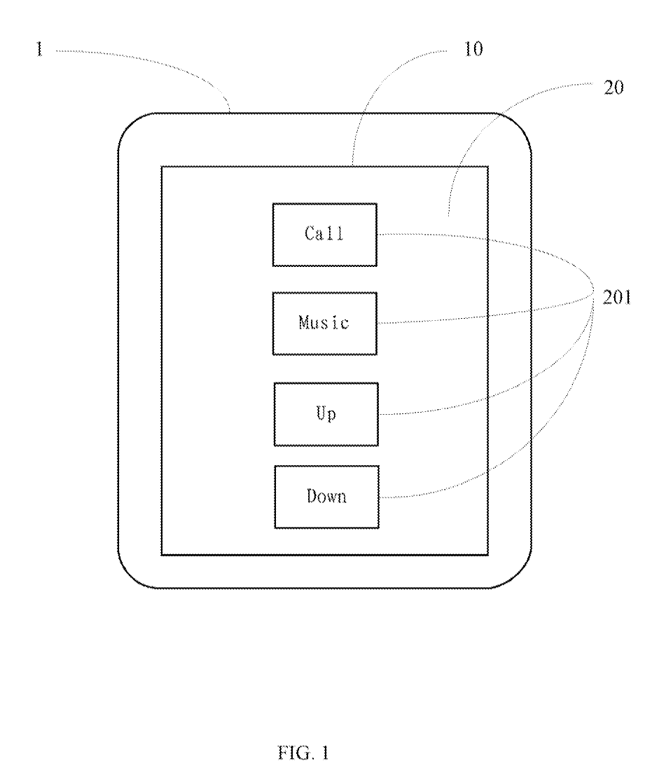

FIG. 1 is a user interface 20 of an electronic device 1 with a feedback work-mode in accordance with an exemplary embodiment. When the device 1 is in the feedback work-mode, the user can operate the device 1 without having to see the device 1 because of provided tactile and audio feedback to guide the user.

The device 1 includes a touch screen 10 for displaying user interfaces 20 and receiving touch operations of the user. The device 1 includes at least one user interface 20. Each user interface 20 includes at least one touch button 201. When one of the touch buttons 201 is pressed, a predetermined function associated with the touch button 201 is activated. In this exemplary embodiment, each user interface 20 further provides audio messages for indicating, for example, location and associated functions of the touch buttons 201. For example, when the device 1 initially displays the user interface 20 as shown in FIG. 1, one audio message played for the user may be, “the buttons in this interface from top to bottom are a call button, a music button, an up button, and a down button, please select one.”

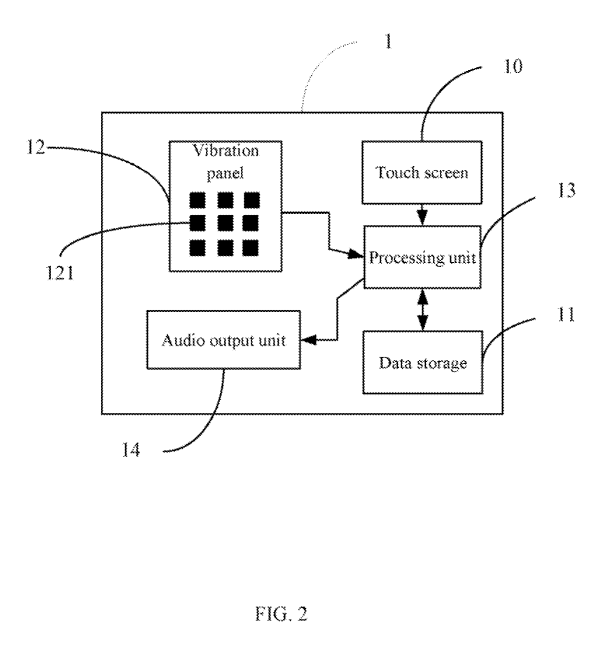

FIG. 2 is a block diagram of the device 1 of FIG. 1 in accordance with a first exemplary embodiment. The device 1 includes a data storage 11, a vibration panel 12, a processing unit 13, and an audio output unit 14. The data storage 11 stores audio messages associated with each user interface 20. The vibration panel 12 includes a number of vibrating elements 121. The vibrating elements 121 may be fixed on the inner wall of the housing (not shown) of the device 1. At least one vibrating element 121 is set adjacent each touch button 201 to cause a touch area of the touch button 201 to vibrate.

When the device 1 is operated to display one user interface 20 in the feedback work-mode, the processing unit 13 accesses the initial audio message associated with that particular user interface 20 from the data storage 11 and plays the message using the audio output unit 14. Meanwhile, the processing unit 13 determines the positions of the touch buttons 201 included in the user interface 20, determines the vibrating elements 121 located near the touch buttons 201 according to the determined positions, and controls the vibrating elements 121 corresponding to the touch buttons 201 to vibrate when the interface 20 is first initialized so that a user can feel where the touch areas for each touch button 201 is located. Thus, the user can identify the touch buttons 201 included in the user interface 20 and select the desired touch button 201 according to the initial audio message and vibration of the touch areas for the touch buttons 201 by the vibrating elements 121. The processing unit 13 activates the predetermined function of the selected touch button 201 in response to the user touch. Thus, the visually impaired can operate the device 1 without Braille keys and greater accessibility of the electronic device is realized. After the predetermined function of the touched button 201 is activated, the processing unit 13 controls the vibrating elements 121 to stop vibrating.

In this exemplary embodiment, when the touch button 201 is touched, another audio message indicating the associated function of the selected touch button 201 can be played to confirm the selection to the user.

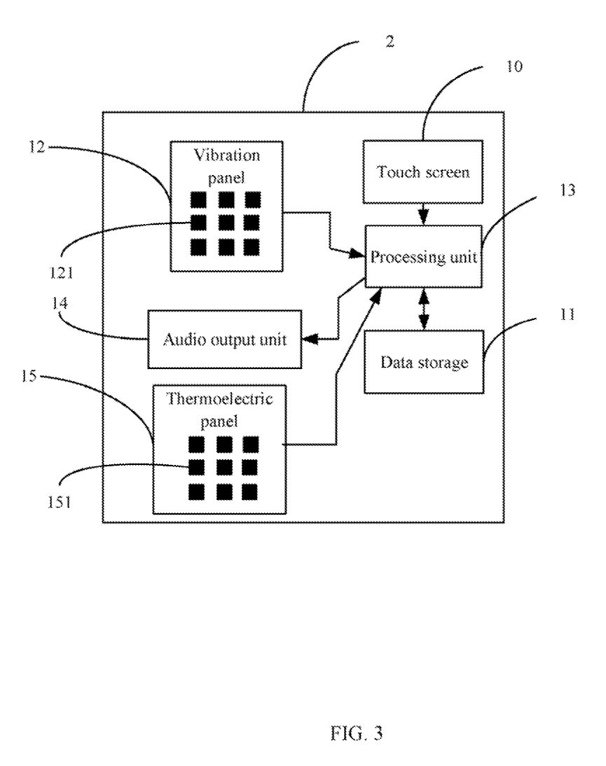

FIG. 3 is a block diagram of an electronic device 2 in accordance with a second exemplary embodiment. Compared with the device 1 of FIG. 1, the device 2 further includes a thermoelectric panel 15. The thermoelectric panel 15 includes a number of heat sources 151. The thermoelectric panel 15 is placed under the touch screen 10 and connected to the processing unit 13. At least one heat source 151 is configured to heat each touch button 201. When a user interface 20 is activated, after determining the positions of the touch buttons 201 included in the user interface 20, the processing unit 13 determines the corresponding heat sources 151 and the corresponding vibrating elements 121 of the touch buttons 201, and activates them to provide feedback to users. Thus, users have heat, vibration, and audio messages to guide them in using the electronic device 2. After the predetermined function of a selected touched button 201 is activated, the processing unit 13 turns off the vibrating elements 121 and the heat source 151.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device, comprising:
a touch screen for displaying a user interface, the user interface comprising at least one touch button which is associated with a predetermined function;
a data storage for storing an audio message which is configured for indicating the at least one touch button comprised in the user interface;
a vibration panel comprising a plurality of vibrating elements, wherein at least one of the plurality of vibrating elements is set adjacent to each of the at least one touch button to cause a touch area of the at least one touch button to vibrate; and
a processing unit for accessing the audio message associated with the user interface from the data storage to output the audio message when the user interface is displayed, determining the position of the at least one touch button comprised in the user interface, determining the at least one vibration element located adjacent to each of the at least one touch button according to the determined position, and controlling the at least one vibration element corresponding to each of the at least one touch button to vibrate.

2. The electronic device as described in claim 1, wherein the audio message is provided for indicating location and associated functions of the at least one touch button comprised in the user interface.

3. The electronic device as described in claim 1, wherein the processing unit controls the plurality of vibrating elements to stop vibrating after the predetermined function of the at least one touched button is activated.

4. The electronic device as described in claim 1, wherein the processing unit outputs another audio message indicating the associated function of the selected touch button is played to confirm the selection to the user.

5. The electronic device as described in claim 1, wherein the vibration panel is placed on the inner wall of a housing of the electronic device.

6. An electronic device, comprising:
a touch screen for displaying a user interface, the user interface comprising at least one touch button which is associated with a predetermined function;
a data storage for storing an audio message which is configured for indicating the at least one touch button comprised in the user interface;
a vibration panel comprising a plurality of vibrating elements, wherein at least one of the plurality of vibrating elements is set adjacent to each of the at least one touch button to cause a touch area of the at least one touch button to vibrate;
a thermoelectric panel comprising a plurality of heat sources, wherein at least one heat source is configured to heat each of the at least one touch button; and
a processing unit for accessing the audio message associated with the user interface from the data storage to output the audio message when the user interface is displayed, determining the position of the at least one touch button comprised in the user interface, determining the at least one vibration element located adjacent to each of the at least one touch button and the heat source for heating the at least one touch button according to the determined position, and controlling the at least one vibration element corresponding to each of the at least one touch button to vibrate and the at least one heat source for heating the each of the at least one touch button to heat.

7. The electronic device as described in claim 6, wherein the audio message is provided for indicating location and associated function of the at least one touch button comprised in the user interface.

8. The electronic device as described in claim 6, wherein the processing unit controls the plurality of vibrating elements to stop vibrating after the predetermined function of the touched button is activated.

9. The electronic device as described in claim 6, wherein the processing unit outputs another audio message indicating the associated function of the selected touch button is played to confirm the selection to the user.

10. The electronic device as described in claim 6, wherein the vibration panel is placed on the inner wall of a housing of the electronic device.

11. The electronic device as described in claim 6, wherein the thermoelectric panel is placed under the touch screen.
